(19) United States
(12) Patent Application Publication
(10) Pub. No.: US 2026/0194131 A1
(43) Pub. Date: Jul. 9, 2026

(54) METHOD FOR OPERATING A DRIVE SYSTEM TO PREVENT MESHING INTERFERENCES IN STRAIN WAVE GEARINGS

(71) Applicant: Schaeffler Technologies AG & Co. KG, Herzogenaurach (DE)

(72) Inventors: Jochen Damerau, Tokyo (JP); Daisuke Kirihara, Chino-city, Nagano-pref (JP)

(73) Assignee: Schaeffler Technologies AG & Co. KG, Herzogenaurach (DE)

(21) Appl. No.: 19/131,533

(22) PCT Filed: Nov. 8, 2023
(86) PCT No.: PCT/DE2023/100842

§ 371 Date: May 21, 2025

(30) Foreign Application Priority Data
Nov. 22, 2022 (DE) 10 2022 130 859.6

(51) Int. Cl. F16H 49/00; F16H 57/01

(52) U.S. Cl. CPC F16H 49/001; F16H 57/01; F16H 2057/016

(57) ABSTRACT

A method for operating a drive system is provided. The drive system includes an electrical machine and a strain wave gearing which has a wave generator that is coupled to the electrical machine, a rigid outer ring having an inner toothing, and an elastically deformable transmission ring having an outer toothing that is in engagement with the inner toothing on the outer ring. The method includes measuring a torque exerted on the transmission ring by way of a torque sensor, and detecting a meshing interference based on the measured torque and storing a critical torque value that has occurred during the meshing interference. The method also includes determining a torque threshold value 10 which is less than or equal to the critical torque value, and controlling the electrical machine in such a way that the torque exerted on the transmission ring is lower than the torque threshold value.

### CROSS-REFERENCE TO RELATED APPLICATIONS

This application is the United States National Phase of International Application PCT/DE2023/100842, filed Nov. 8, 2023, which claims priority to German Application 10 2022 130 859.6, filed Nov. 22, 2022. The disclosures of the above applications are incorporated herein by reference.

### TECHNICAL FIELD

The disclosure relates to a method for operating a drive system that includes an electrical machine and a strain wave gearing. Furthermore, the disclosure relates to a drive system having an electrical machine and a strain wave gearing.

### BACKGROUND

Strain wave gearings (also known as harmonic drive, ellipto-centric gear mechanism) enable an almost play-free power transmission with a high transmission ratio, and are therefore suitable for applications that require precise movements and a small space requirement. Since high torques can be generated with relatively small motors due to the high transmission ratio, strain wave gearing can be used to create very compact drive mechanisms that are used, for example, in robotics.

The main components of a strain wave gearing are a wave generator (“wave generator”), a rigid outer ring (“circular spline”) with inner toothing and a transmission ring (“flexspline”) with outer toothing arranged therebetween. In contrast to rigid gears, the transmission of torque between the wave generator and the outer ring is based on elastic deformation, in which the transmission ring is deformed into an oval by the wave generator in such a way that it engages with the outer ring on two opposite sides of its circumference. As the wave generator rotates, the transmission ring rolls on the outer ring, so that a torque is transmitted between the transmission ring and the outer ring through the interlocking toothings. Thus, the transmission ratio of the transmission is determined by the difference in the number of teeth on the transmission ring and the outer ring.

If an excessively strong torque is applied during operation, for example when the gearbox is working against a high resistance, the engagement between the transmission ring and the outer ring can be at least partially lost, so that the teeth of the transmission ring skip over the teeth of the outer ring (“ratcheting”). While the rotation of the transmission ring and that of the outer ring are strictly coupled during normal operation, such a meshing interference temporarily leads to an uncontrolled relative rotation between the two rings. This creates an unknown angular offset on the output side compared to the drive side, which makes precise control of the angular position impossible. Since the condition of the transmission does not indicate whether such a meshing interference has occurred, the search for the cause of the subsequent malfunction is made more difficult.

In this context, a method is known from JP 2021014876 A in which the torque acting on the output side of a strain wave gearing is measured and compared with two threshold values. Exceeding the first threshold value indicates a meshing interference, while exceeding the second threshold value indicates possible buckling of the transmission ring. A disadvantage of this method is that the critical torque (“ratcheting torque”) at which a meshing interference is likely to occur varies from transmission to transmission. On the other hand, such a simple threshold value method cannot reliably determine whether a meshing interference has actually occurred or whether the temporarily occurring high torque was reduced without interference. Furthermore, these meshing interferences can lead to damage in the strain wave gearing, where meshing interferences are a self-reinforcing phenomenon with increasing operating time. Locally increased wear on the toothing of the strain wave gearing and high torques required on the output side in repetitive duty cycles lead to an increased potential for local meshing interferences.

DE 10 2021 113 139 B3 describes a method for operating a robot device having a transmission and a sensor device, with the help of which a torque applied to the transmission is determined. It includes a determination step and a comparison step, where the operating parameters of the robot device are adjusted depending on the comparison.

JP 2021-14 876 A describes a failure determination device for a wave gearing including a torque detector on an output side of the wave gearing and a determination unit for determining the failure of the wave gearing based on the torque detected by the torque detector.

DE 10 2019 210 795 A1 describes a strain wave gearing having a vibration sensor, the signals of which are used to determine load data and/or are further processed to provide information about the transmission condition and/or to detect critical operating conditions.

Against this background, the object is to provide a method and a system that can reduce the probability of meshing interferences occurring.

### SUMMARY

One aspect of the disclosure provides a method for operating a drive system, where the drive system includes an electrical machine and a strain wave gearing which has a wave generator coupled to the electrical machine. The drive machine also includes a rigid outer ring having inner toothing, and an elastically deformable transmission ring having outer toothing in engagement with the inner toothing of the outer ring. The method includes the following method steps:
measuring a torque exerted on the transmission ring by way of a torque sensor,
detecting a meshing interference based on the measured torque and storing a critical torque value which has occurred during the meshing interference,
determining a torque threshold value which is less than or equal to the critical torque value, and
controlling the electrical machine in such a way that the torque exerted on the transmission ring is lower than the torque threshold value.

Furthermore, a drive system is also provided which has an electrical machine and a strain wave gearing which includes a wave generator coupled to the electrical machine, a rigid outer ring having inner toothing, and an elastically deformable transmission ring having outer toothing in engagement with the inner toothing of the outer ring. The drive system is configured to carry out the following method steps:
measuring a torque exerted on the transmission ring by way of a torque sensor,
detecting a meshing interference on the basis of the measured torque and storing a critical torque value which has occurred during the meshing interference,
determining a torque threshold value which is less than or equal to the critical torque value, and
controlling the electrical machine in such a way that the torque exerted on the transmission ring is lower than the torque threshold value.

If a meshing interference has been detected based on the measured torque, the critical torque value that has occurred during the meshing interference is stored. This torque value can correspond to a ratcheting torque.

In some implementations, after the detection of a meshing interference and the storage of the critical torque value, a torque threshold value is determined which is lower than or equal to the critical torque value. Subsequently, the electrical machine is controlled in such a way that the torque exerted on the transmission ring is lower than or equal to the level of the previously determined torque threshold value. This example makes it possible to significantly reduce the probability of further meshing interferences occurring. In some examples, a further meshing interference can be completely avoided by the disclosed method and drive system.

The wave generator of the strain wave gearing is formed by a disc, connected to a drive shaft, having an oval, for example elliptical, shape. The disc may have a rolling bearing shrunk onto its circumference with a thin, elastically deformable race and several rolling elements. The transmission ring can, for example, be cup-shaped or top-hat-shaped (“silk hat” shaped), i.e., the transmission ring is formed, for example, by a cylindrical wall of a cup-shaped or top-hat-shaped bushing, which can be made of steel, for example. Thus, these are common design options for the transmission ring, which can be used to preload the transmission ring relative to the wave generator. In some examples, the measured torque can be analyzed and evaluated via an evaluation unit, which determines a change over time in the torque and compares it with a reduction threshold value. For example, a rate of change over time can be determined and compared with the reduction threshold value, such as by forming a difference or a numerical derivation of the torque measurement values. It is also conceivable that the comparison checks whether the measured torque decreases by at least a predetermined amount within a predetermined period of time. In some examples, reduction threshold value can be a relative reduction threshold value, i.e., the comparison checks whether the measured torque has decreased by at least a predetermined percentage. If the reduction threshold value is exceeded, a warning signal is triggered, which can be transmitted to an external data processing unit, such as a monitoring and control unit of the strain wave gearing.

The detection of the meshing interference can be based on a curve over time of the measured torque on the deformable transmission ring. This represents the dynamic behavior of the torque transmission before and during the meshing interference. Typically, an excessively high torque builds up prior to the meshing interference, which ultimately causes the teeth of the transmission ring to lose engagement with the outer ring and skip over its teeth. The accumulated torque is greatly reduced within a short period of time. This decrease in torque can serve as a characteristic signature of a meshing interference and enable the reliable detection of the meshing interference.

Furthermore, during detection, the measured torque can be compared with at least one threshold value, where the decrease over time of the measured torque is only determined and compared with the reduction threshold value if an exceedance of the threshold value is detected. The threshold value is used to distinguish the load peaks that occur during normal operation from excessively high torques that indicate or signal a meshing interference. For example, during the start or stop process, the transmission must overcome the inertia of the load coupled to the outlet side or output side, which results in a briefly increased torque (start/stop torque). If an obstruction occurs on the output side, for example if a robot arm actuated by the gearbox hits an obstacle, the transmission briefly works against a high resistance (impact torque) before the impact is registered. At very high torques, the mechanical load capacity of the transmission ring is ultimately exceeded, causing it to buckle (buckling torque, torsional buckling, torsional flexural buckling). The ratcheting torque is between the impact torque and the buckling torque, the ratcheting torque typically triggers meshing interferences. The threshold value used in the method can, for example, correspond to the impact torque or the ratcheting torque. In some examples, the threshold value is between the impact torque and the buckling torque or between the impact torque and the ratcheting torque.

In some implementations, the critical torque value that has occurred during the meshing interference, for example of the ratcheting torque, can be stored in an internal storage unit in or on the strain wave gearing, where this can be arranged in the evaluation unit of the input-side electrical machine. Alternatively or additionally, it is conceivable that the critical torque value, such as the critical ratcheting torque, can be transmitted to a remote storage unit via a wired or wireless connection.

In some examples, the torque threshold value is determined based on the detected critical torque. The detected critical torque may be included in the determination of the torque threshold value. In some examples, a safety factor is stored in an evaluation unit, where this defines a relationship between the detected critical torque and the torque threshold value to be determined. For example, it can be provided that the torque threshold value is determined as a predetermined percentage of the detected critical torque. In order to maintain the efficiency and effectiveness of the strain wave gearing, the percentage should not be set too low, as otherwise the strain wave gearing can only deliver a fraction of the required torque. For example, the percentage can be selected between 80% and 95%. The safety factor or percentage can be adjusted by the evaluation unit during operation or can be a fixed, empirically determined value. Having a variable safety factor or percentage is advantageous, since this can be estimated more conservatively with increasing service life, for example. With progressive service life and increasing wear, the probability of a meshing interference occurring increases. Thus, the safety factor or percentage in a strain wave gearing with a long operating time can be selected to be lower to avoid a recurrence of a meshing interference. For a strain wave gearing with only a few operating hours, the safety factor or percentage can be selected to be larger, since a meshing interference is less likely. Alternatively, a safety margin can be stored in the evaluation unit, for example an absolute value that defines the torque threshold value as the difference between the detected critical torque and the absolute value.

In some implementations, it is provided that further meshing interferences are detected based on the measured torque, and the further critical torque values occurring during these meshing interferences are stored, where the torque threshold value is additionally determined based on the stored further critical torque values. In this context, a meshing interference describes a “slippage” of the teeth of the transmission ring relative to the teeth of the outer ring. In this case, one or more teeth can be skipped in the event of a meshing interference, where the teeth must be arranged next to one another. The torque threshold value is then determined based on several, such as all, stored critical torque values. In this way, the torque threshold value can be further lowered, for example, if another meshing interference occurs at a critical torque that is below the currently used torque threshold value. For example, a lowest critical torque value can be determined based on the multiple critical torque values and this can then be used to determine the torque threshold value.

In some implementations, it is provided that during an initial commissioning of the drive system or during the manufacture of the drive system, an initial, critical torque value is determined and stored and the torque threshold value is additionally determined based on the initial, critical torque value. Since even one-off meshing interferences can cause increased wear, it is more than desirable to avoid meshing interferences for as long as possible. A torque threshold value preset prior to the first operation makes it possible to reduce the probability of a meshing interference occurring, such as in the first hours of operation. For example, a torque threshold value can be determined or set based on data obtained experimentally during production, from empirical values or from data determined during the initial start-up of the drive system. Initial critical torque values can be determined, particularly during a series of experimental tests, which serve as the basis for the first torque threshold value.

In some implementations, when the meshing interference is detected, a torque curve and/or a load curve is additionally stored and the torque threshold value is additionally determined based on the stored torque curve and/or load curve. Storing the torque or load curve makes it possible to detect whether torque and/or load maxima occur repeatedly, such as when certain areas, for example teeth, of the inner toothing and/or outer toothing are in engagement with one another. This allows wear and tear of these specific areas, such as teeth, to be detected early. If wear is detected in a certain area, the torque threshold value can be selected in such a way that further wear in this area is minimized or the risk of meshing interferences occurring in this area is reduced.

In some implementations, the drive system has a position sensor, where the position of the wave generator is stored when a meshing interference occurs. By way of the position sensor, an area, such as a tooth, of the transmission ring can be assigned to the meshing interference.

In some examples, for controlling the electrical machine, at least one control parameter is set as a function of the determined torque threshold value, namely a control parameter which influences the acceleration behavior and/or the braking behavior of the electrical machine. Alternatively, the control parameter can influence the cycle time for a duty cycle.

In some implementations, the electrical machine is additionally controlled in such a way that the electrical machine is put into a freewheel state when an overload torque threshold value that is greater than the determined torque threshold value is exceeded and/or when a predetermined overload torque increase is exceeded. The freewheel state describes a state in which the electrical machine does not provide any input-side torque. The electrical machine can be switched off so that the electrical machine acts as a damper. The freewheel state is not only relevant for the protection of the strain wave gearing but also for the protection of personnel in applications where the drive system is used in a robot arm of a collaborative robot. Such collaborative robots work closely with a person, for example, and the person can be protected in the event of a collision with the robot by putting the electrical machine into freewheel state.

In the strain wave gearing, the transmission ring may be arranged in a fixed position. The wave generator can form the input of the strain wave gearing and the rigid outer ring can form the output of the wave transmission. Both the wave generator and the outer ring are preferably mounted so that they can rotate.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows an exemplary robot in a schematic representation;

FIG. 2 shows a schematic sectional view of a strain wave gearing, as well as an intact tooth engagement during operation;

FIG. 3 shows a schematic meshing interference and a deformation of a transmission ring for measuring a torque;

FIG. 4 shows a sectional view of a drive system;

FIG. 5 shows a sectional view of a strain wave gearing;

FIG. 6 shows a first torque curve with a meshing interference on the basis of which a torque threshold value is determined and a further torque curve taking into account the determined torque threshold value;

FIG. 7 shows a second torque curve with a meshing interference on the basis of which a torque threshold value is determined and a further torque curve taking into account the determined torque threshold value;

FIG. 8 shows a load cycle of a drive system;

FIG. 9 shows a section of the load cycle from FIG. 8;

FIG. 10 shows a control loop for the drive system; and

FIG. 11 shows a schematic flow diagram of an exemplary method for operating a drive system.

Like reference symbols in the various drawings indicate like elements.

### DETAILED DESCRIPTION

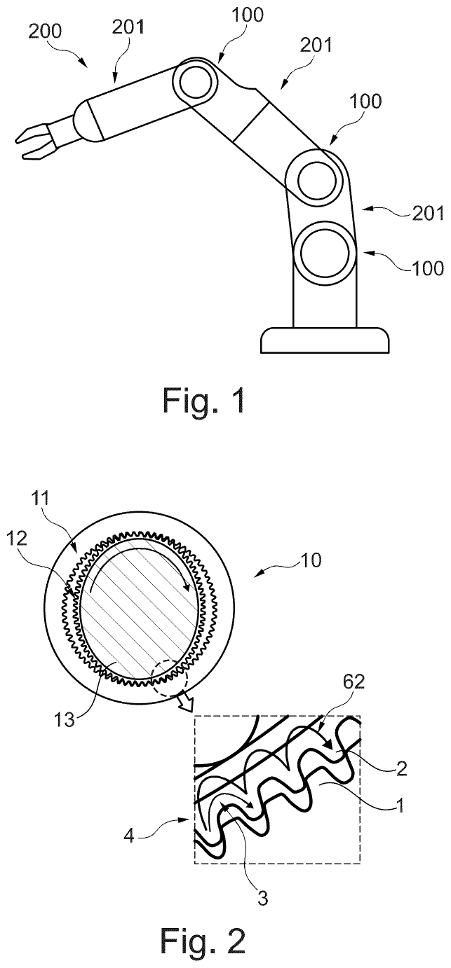

FIG. 1 shows in a schematic representation an exemplary robot designed as an industrial robot 200 having several arm segments 201, each being rotatably connected via drive modules 100. Even if the industrial robot 200 shown here has three arm segments 201 and three drive modules 100, the industrial robot 200 may have a different number of arm segments 201 and drive modules 100, for example four, five, six, or seven of each. Furthermore, a drive module 100 can be used for any robot joints. Such industrial robots 200 are often used as collaborative robots, which work in close cooperation with humans.

FIG. 2 schematically shows a typical structure of a strain wave gearing 10. The main components of the strain wave gearing 10 are a wave generator 13, a rigid outer ring 11 (“circular spline”) with inner toothing 1 and a flexible transmission ring 12 (“flexspline”) with outer toothing 2 arranged therebetween. The wave generator 13 is formed by an oval disc connected to a drive shaft, on the circumference of which several rolling elements 14 (not shown) are arranged, which roll on the inside of the transmission ring 12. The flexible transmission ring 12 is brought into engagement with the outer ring 11 by the wave generator 13, where each individual tooth of the transmission ring 12 is moved out of a gap between two teeth of the outer ring 11 during a 180° rotation of the wave generator 13, and migrates into the respective subsequent gap (indicated by the arrow 3 in section 4). In this way, the transmission ring 12 rotates relative to the outer ring 11 in the direction opposite to the rotation of the wave generator 13, where a torque is transmitted between the two rings 11 and 12. The output of the strain wave gearing 10 can be implemented either via the transmission ring 12 (with a fixed outer ring 11) and via the outer ring 11 (with a fixed transmission ring 12). In the following, the output of the strain wave gearing is formed by the outer ring 11.

As a result of an excessively high torque, the engagement between the toothings 1, 2 can be temporarily lost, so that a tooth of the transmission ring 12 can skip several teeth of the outer ring 11 during a meshing interference 62 (indicated by the arrow 62). While a strict relationship between the respective rotation angles is maintained by the toothing between the rings 11, 12 during normal operation, such a meshing interference leads to an uncontrolled relative rotation and a resulting angular offset 64.

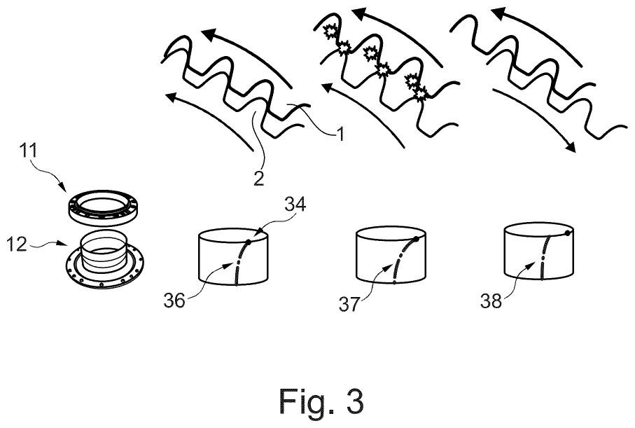

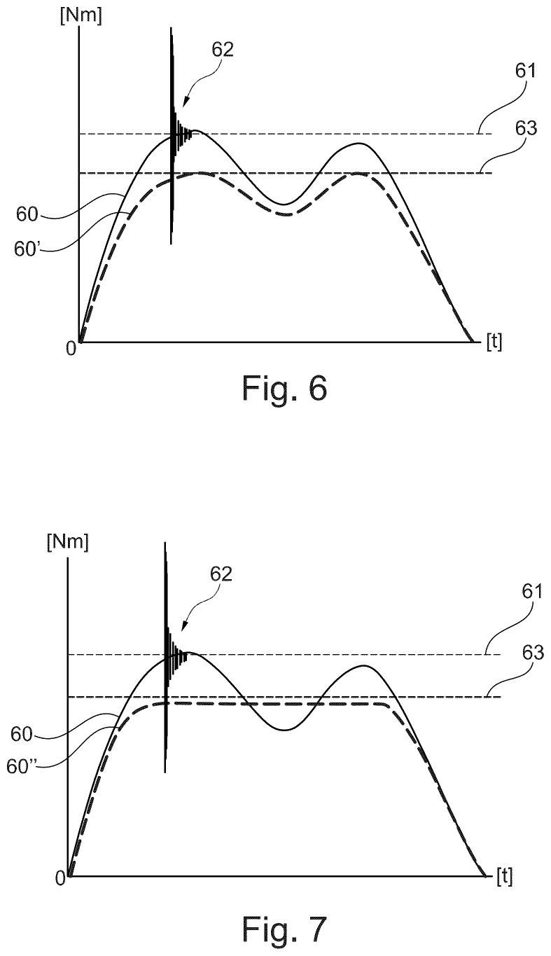

FIG. 3 schematically shows the dynamic deformation of the transmission ring 12 in different phases of the meshing interference. The transmission ring 12 is designed as a top-hat-shaped bushing (“silk hat”) (see figure on the left), the upper edge of which has the outer teeth 2, which in turn is brought into engagement with the inner teeth 1 of the outer ring 11. The degree of deformation of the cylindrical wall of the transmission ring 12 is shown at three consecutive points in time together with the corresponding state of the toothings 1, 2. The position of the outer ring 11 is marked by a reference point 34 at the upper edge of the transmission ring 12, while the lines 36, 37, 38 represent the corresponding twisting of the transmission ring 12. In the first phase, the engagement between the rings 1, 2 is still intact, but an ever-increasing torque builds up due to the elastic twisting 36 of the transmission ring 12. With increasing twisting, the torsional stiffness of the transmission ring 12 increases so that the torque increases steeply and finally reaches its maximum value at the deformation 37. When this critical value is reached, a meshing interference 62 is triggered, in which the engagement of the toothings 1, 2 is at least partially canceled, the twisting springs back and the outer toothing 2 skips relative to the inner toothing 1. After the skipping, the line 38 no longer ends at the reference point 34 as before, but has an angular offset therefrom that corresponds to the resulting offset between the rotation angles of the two rings 2, 3. Based on this twisting, a torque can be measured by way of a torque sensor 15, for example one or more strain gauges, and utilized in the form of a torque curve 60 (see FIG. 6) over time.

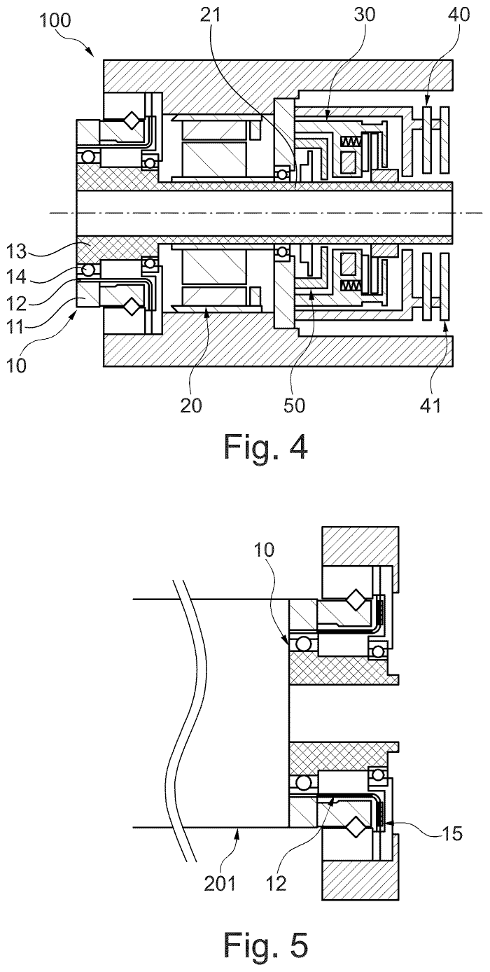

FIG. 4 shows an exemplary drive module 100 for moving an arm segment 201 of an industrial robot 200, which can be used in the industrial robot 200 according to FIG. 1. The drive module 100 includes a transmission designed as a strain wave gearing 10, an electrical machine 20, and a brake device 30. A further component of the drive module 100 is an electronic unit 40. The wave generator 13 is formed by an oval disc, on the circumference of which several rolling elements 14 are arranged, which roll on the inside of the transmission ring 12.

The wave generator 13 of the strain wave gearing 10 is coupled to the electrical machine 20, in this case to the rotor shaft 21 of the electrical machine 20. The electrical machine 20 can be designed as an axial flow machine or as a radial flow machine.

The rotor shaft 21 and thus also the wave generator 13 are further coupled to the brake device 30, by way of which the rotor shaft 21 can be decelerated and/or fixed. The rotor shaft 21 is also coupled to a position sensor 50, which can be used to determine a position, in this case an angular position of, the rotor shaft 21. The position sensor 50 may be designed as an optical or magnetic rotary encoder or rotary angle encoder. From the combination of the torque sensor 15 and the position sensor 50, the amount of torque between the rings 11, 12, and the direction of rotation of the wave generator can be detected.

FIG. 5 shows a detail of the strain wave gearing 10 of the drive module 100 according to FIG. 4. As shown, a torque sensor 15 is arranged on the elastically deformable transmission ring 12, by way of which the torque exerted on the transmission ring 12 is measured. The torque sensor 15 includes one or more strain gauges with which the applied torque can be measured via the torsion of the transmission ring 12 caused thereby. The torque sensor 15 is connected to an evaluation unit 41 of the drive module 100, which continuously or quasi-continuously receives measured values of the torque sensor 15. As shown, the evaluation unit 41 is designed as part of the electronic unit 40, see. FIG. 4.

In FIG. 6 and FIG. 7, two torque curves 60, 60′ are shown over time t, which can occur when carrying out the method according to the disclosure. The first torque curve 60 represents an operating situation in which a meshing interference 62 occurs and is detected. The second torque curve 60′ represents a corresponding operating situation in which the electrical machine is controlled as a result of the detected meshing interference 62 in such a way that the torque on the transmission ring 12 is lower than a torque threshold value 63, which is determined based on a critical torque value that has occurred during the meshing interference.

The torque exerted on the transmission ring 12 is measured by way of one or more torque sensors 15. The meshing interference 62 is detected based on the measured torque. The meshing interference 62 can be seen in FIGS. 6 and 7 as a damped vibration. The critical torque value occurring in the event of meshing interference 62, for example the ratcheting torque 61, which occurs when teeth 1, 2 first “slip through”, is stored. The torque threshold value 63 is then determined based on the critical torque value, where this value is lower than or equal to the critical torque value 61. As shown by the second torque curve 60′, the electrical machine is then controlled in such a way that the torque exerted on the transmission ring 12 is lower than the determined torque threshold value 63.

The difference between the example shown in FIG. 6 and the example shown in FIG. 7 lies in the second torque curve 60′, 60″, which occurs when the electrical machine is controlled with the torque threshold value 63. While the second torque curve 60′ according to FIG. 6 has the same phases of torque increase and decrease as the first torque curve 60, the second torque curve 60″ according to FIG. 7 is the result of a control strategy in which the phases of torque increase and decrease are changed compared to the first torque curve 60. Such a modified control strategy can be achieved, for example, by adapting control parameters that are used to control the electrical machine.

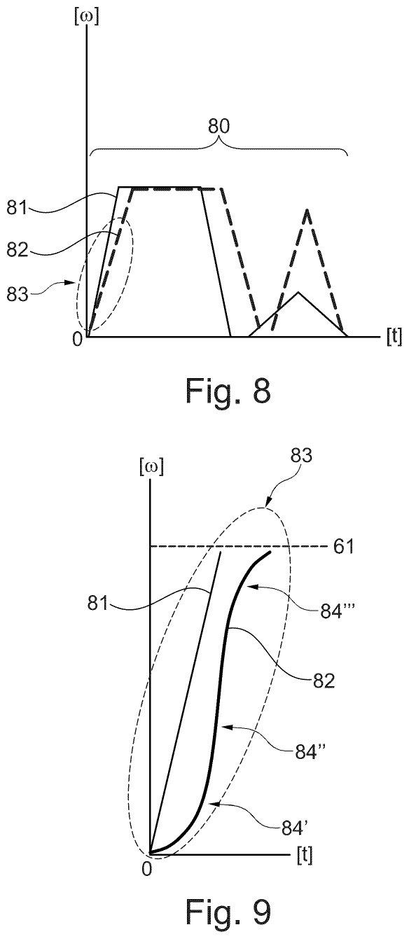

FIG. 8 illustrates the changes in an RPM curve during an exemplary duty cycle 80 of a drive system, which can result from the change of control parameters, as explained in connection with FIG. 7. This duty cycle 80 represents a repetitive task of a drive system. A first RPM curve 81 is shown, which corresponds to the first torque curve 62. As a result of the determination of the torque threshold value 63 and the changes in the control parameters, a second RPM curve 62 results for the same duty cycle, which corresponds to the second torque curve 60″.

In FIG. 8, it can be seen that the acceleration and braking behavior has changed in the second RPM curve 82 compared to the first RPM curve 81.

FIG. 9 shows a section 83 of the curves 81, 82 from FIG. 8. It can be seen that the second RPM curve 82 has an initially lower acceleration (84′) than the first RPM curve 81, which changes to an acceleration (84″) that is increased compared to the first RPM curve 81 and ends at the end of the acceleration process (84″″) again in a lower acceleration than the first RPM curve 81.

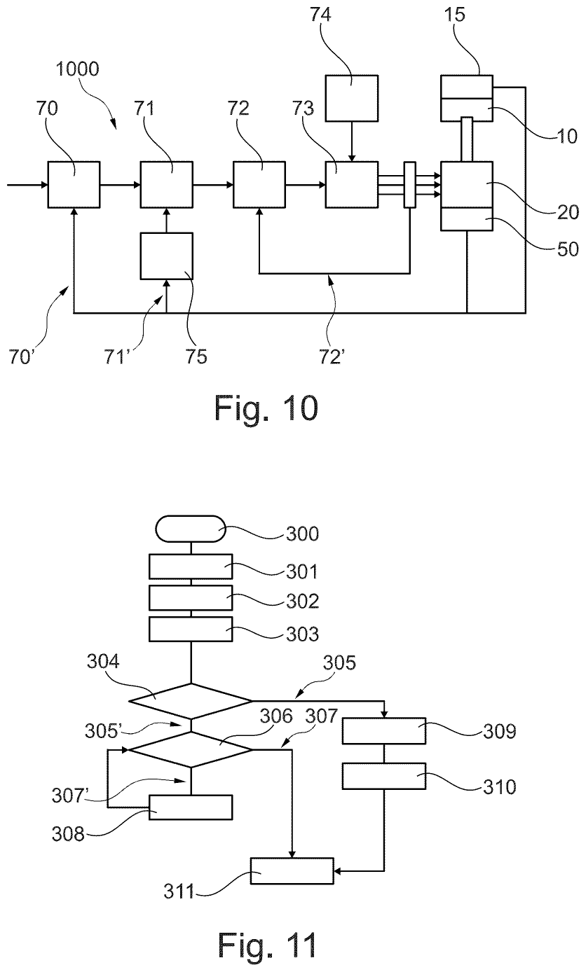

In FIG. 10, an exemplary control system 1000 for a drive system is shown.

The control system 1000 includes a position controller 70, a speed controller 71, a current controller 72, an inverter 73, a converter 74, an RPM-speed converter 75, the electrical machine 20, the position sensor 50, the strain wave gearing 10 and the torque sensor 15. The control system 1000 is designed in such a way that it includes three cascaded control loops. A first control loop is the position control loop 70′. In addition, the control system 1000 has a speed control loop 71′ and a current control loop 72′.

The torque threshold value determined within the scope of the method can be taken into account in the current control loop. The torque threshold value 63 can be fed to the current controller 72 so that the electrical machine 20 is controlled in such a way that the torque exerted on the transmission ring 12 is lower than the torque threshold value 63. If control parameters are changed in the method depending on the determined torque threshold value 63, these changes can affect the speed controller 71 and, optionally, also the position controller 70.

FIG. 11 shows a flow chart of an exemplary method for avoiding meshing interferences 300. In an optional, first method step 301, an initial torque threshold value can be defined during initial start-up of the drive system or during manufacture of the drive system, which is taken into account as the upper limit of the torque on the transmission ring 12 when controlling the electrical machine. The initial torque threshold value can be determined by measuring an initial, critical torque value or based on empirical values from identical drive systems. The torque threshold value 63 can thus be preset before the drive system is first started up, so that the occurrence of a first meshing interference 62 is avoided at an early stage of operation.

After start-up of the drive system, meshing interferences may still occur at a specified torque threshold value, for example due to wear. In a second method step 302, such a meshing interference 62 can be detected. For this purpose, the torque exerted on the transmission ring 12 is measured by way of a torque sensor 15. In a third method step 303, the critical torque value that occurred during the meshing interference 62 is stored.

Subsequently, in a first query 304, it is checked whether the measured torque is greater than a predetermined overload torque threshold value or whether an increase in the measured torque is greater than a predetermined overload torque increase. If one of these threshold values is exceeded, the electrical machine is put into a freewheel state 309. Following the transition to the freewheel state 309, a fifth method step 310 checks whether the present torque value is reasonable for the drive system or is still considerably too high. If the torque value is too high, an emergency shutdown is initiated in the sixth method step 311.

If the query 305′ is negative, the method 300 continues with a second query 306. The second query 306 checks whether the present torque exceeds the stored ratcheting torque 61. The stored ratcheting torque 61 describes the last or a plurality of stored critical torques that occurred. If the second query 307 is positive, the system jumps directly to the sixth method step 311, which initiates an emergency shutdown.

If the second query 307′ is negative, the process advances to the fourth step 308. The fourth method step 308 includes the normal operation of the drive system by controlling the electrical machine 20 in such a way that the torque exerted on the transmission ring 12 is lower than the determined torque threshold value 63.

If several meshing interferences 62 occur during operation of the drive system, all critical torque values occurring during these meshing interferences 62 are stored. The torque threshold value 63 used for the control in method step 308 is then determined based on all stored critical torque values, for example in such a way that the lowest critical torque value is determined and this is used to determine the torque threshold value.

A number of implementations have been described. Nevertheless, it will be understood that various modifications may be made without departing from the spirit and scope of the disclosure. Accordingly, other implementations are within the scope of the following claims.

### REFERENCE NUMERALS

1-Inner toothing
2-Outer toothing
3-Movement of a tooth of the outer toothing
4-Section
10-Strain wave gearing
11-Outer ring
12-Transmission ring
13-Wave generator
14-Rolling element
15-Torque sensor
20-Electrical machine
21-Rotor shaft
30-Brake device
34-Reference point
36, 37, 38-Deformation lines
40-Electronic unit
41-Evaluation unit
50-Position sensor
60-Torque curve
60′-New torque curve
60″-Alternative new torque curve
61-Ratcheting torque
62-Meshing interference
63-New torque threshold value
70-Position controller
70′-Position control loop
71-Speed controller
71′-Speed control loop
72-Current controller
72′-Current control loop
73-Inverter
74-Converter
75-RPM-speed converter
80-Duty cycle
81-RPM curve
82-New RPM curve
83-Section of the curves
84′, 84″, 84″ “′-Modified acceleration
100-Drive module
200-Robot
201-Arm segment
300-Method for avoiding meshing interferences
301-First method step
302-Second method step
303-Third method step
304-First query
305-Positive first query
305′-Negative first query
306-Second query
307-Positive second query
307′-Negative second query
308-Fourth method step
309-Freewheel state
5 310-Fifth method step
311-Sixth method step
1000-Control system for a drive system

1. A method for operating a drive system, the drive system including an electrical machine and a strain wave gearing, which has a wave generator coupled to the electrical machine, a rigid outer ring having inner toothing, and an elastically deformable transmission ring having an outer toothing in engagement with the inner toothing of the outer ring, the method comprising:
measuring a torque exerted on the transmission ring by a torque sensor;
detecting a meshing interference based on the measured torque;
storing a critical torque value which has occurred during the meshing interference;
determining a torque threshold value which is less than or equal to the critical torque value;
controlling the electrical machine in such a way that the torque exerted on the transmission ring is lower than the torque threshold value; and
controlling the electrical machine in such a way that, when the torque threshold value or the stored critical torque value is exceeded, the electrical machine is operated in a freewheel state.

2. The method of claim 1, wherein the torque threshold value is determined based on the detected critical torque.

3. The method of claim 2, further comprising:
detecting meshing interferences based on the measured torque, and
storing the further critical torque values occurring during these meshing interferences,
wherein the torque threshold value is additionally determined based on the stored further critical torque values.

4. The method of claim 2, wherein during an initial commissioning of the drive system or during the manufacture of the drive system, the method further includes:
determining an initial, critical torque value; storing the initial, critical torque value; and
determining the torque threshold value based on the initial, critical torque value.

5. The method of claim 1, wherein, when the meshing interference is detected, a torque curve and/or a load curve is additionally stored and the torque threshold value is additionally determined based on the stored torque curve and/or load curve.

6. The method of claim 2, wherein, for controlling the electrical machine, at least one control parameter is set as a function of the determined torque threshold value, namely a control parameter which influences the acceleration behavior and/or the braking behavior of the electrical machine.

7. A drive system comprising:
an electrical machine; and
a strain wave gearing which comprises a wave generator coupled to the electrical machine, a rigid outer ring having inner toothing, and an elastically deformable transmission ring having outer toothing in engagement with the inner toothing of the outer ring,
wherein the drive system is configured to carry out the following method steps:
measuring a torque exerted on the transmission ring by a torque sensor,
detecting a meshing interference based on the measured torque and storing a critical torque value which has occurred during the meshing interference,
determining a torque threshold value which is less than or equal to the critical torque value,
controlling the electrical machine in such a way that the torque exerted on the transmission ring is lower than the torque threshold value, and
controlling the electrical machine in such a way that, if the torque threshold value or the stored critical torque value is exceeded, the electrical machine is operated in a freewheel state.

8. The drive system of claim 7, wherein the torque threshold value is determined based on the detected critical torque.

9. The drive system of claim 8, wherein the drive system is further configured to carry out the following method steps:
detecting meshing interferences based on the measured torque, and
storing the further critical torque values occurring during these meshing interferences,
wherein the torque threshold value is additionally determined based on the stored further critical torque values.

10. The drive system of claim 7, wherein during an initial commissioning of the drive system or during the manufacture of the drive system, the drive system is further configured to carry out the following method steps:
determining an initial, critical torque value; storing the initial, critical torque value; and
determining the torque threshold value based on the initial, critical torque value.

11. The drive system of claim 7, wherein, when the meshing interference is detected, a torque curve and/or a load curve is additionally stored and the torque threshold value is additionally determined based on the stored torque curve and/or load curve.

12. The drive system of claim 7, wherein, for controlling the electrical machine, at least one control parameter is set as a function of the determined torque threshold value, namely a control parameter which influences the acceleration behavior and/or the braking behavior of the electrical machine.
